(19) United States
(12) Patent Application Publication
(10) Pub. No.: US 2007/0100600 A1
(43) Pub. Date: May 3, 2007

(54) Explication system and method

(75) Inventors: Chaucer Chiu, Taipei (TW); Anthony Zhou, Taipei (TW)

Correspondence Address: EDWARDS & ANGELL, LLP, P.O. BOX 55874, BOSTON, MA, 02205, US

(73) Assignee: Inventec Corporation, Taipei (TW)

(21) Appl. No.: 11/262,265

(22) Filed: Oct. 28, 2005

(51) Int. Cl. G06F 17/28

(52) U.S. Cl. 704/4

(57) ABSTRACT

An explication system and method provides a storage unit for storing a plurality of words, explications corresponding to the words and a plurality of roots; segments a word to be searched according to the contents stored in the storage unit so as to segment the searched word into at least a root and at least a remaining portion composed of the remaining letters; judges whether the remaining portion has an explication stored in the storage unit; and explains the root and remaining portion according to the explications stored in the storage unit. Thus, words not stored in the word database can still be accurately explained, and the number of the words that can be explained is increased.

### FIELD OF THE INVENTION

The present invention relates to a word translation technology, and more specifically, to an explication system and method for explaining the meaning of a word having at least one root.

### BACKGROUND OF THE INVENTION

With the wide use of Internet, the chance to record materials in a foreign language increases. In order to smoothly and rapidly spread information around the world, a higher requirement is brought forward to language tools, thus various translation systems are introduced. For example, currently a very common language translation method, which has a good effect, is to search a word in a word database preinstalled in a computer or portable electronic devices (such as electronic dictionaries, mobile phones and language translation machines).

However, taking English-to-Chinese translation as an example, the word number stored in the word database of current translation systems may be up to millions, which is still incomplete because large numbers of new English words (such as proper nouns in biology and physics) are continuously being invented. There is no such system which stores all words therein; as a result, it is very common to get a result of “searched word not found” during searching a word in the word database of the translation system. Furthermore, because the number of English words is vast that even a native English speaker cannot remember all the words, thus not only the English-to-Chinese translation, but also English-to-English explication faces the above problem. Although it is possible to passively solve the above problem by increasing the number of words in the word database, it is more preferable to positively solve the above problem by processing the word not found in the word database so as to provide an explication closest to the word per se.

Conventional means to process a unavailable word employs an approximation matching method, for example, if a matching Chinese explication of the word “autocriticism” is not recorded in the word database, the word “autocracy” will be returned as the approximated match of the word, which, nonetheless, has a meaning far different from the word “autocriticism” per se, therefore, the above method is inappropriate.

Consequently, how to provide a method to more accurately translate or explain those words not found in the word database has become a problem desired to be solved.

### SUMMARY OF THE INVENTION

Regarding the drawbacks of the abovementioned conventional technologies, the primary objective of the present invention is to provide an explication system and method, which segments a word into at least into a root and at least a remaining portion other than the root; the root and the remaining portion are respectively explained so as to more accurately explain the word not found in the word database, and further to increase the number of words that can be explained.

In accordance with the above and other objectives, the present invention proposes an explication system and method.

The system comprises: a storage unit for storing a plurality of words, explications corresponding to the words and a plurality of roots; a root segmenting module for segmenting the word to be explained according to the contents stored in the storage unit into at least a root and at least a remaining portion composed of the remaining letters; a judging module for judging whether the remaining portion has an explication stored in the storage unit; and an explication module for explaining the root and remaining portion according to the explications stored in the storage unit, so as to obtain the explication of the word being judged by the judging module.

The method comprises: providing a storage unit for storing a plurality of words, explications corresponding to the words and a plurality of roots; segmenting a word according to the contents stored in the storage into at least a root and at least a remaining portion composed of the remaining letters; judging whether the remaining portion has an explication stored in the storage unit; and explaining the root and remaining portion according to the explications stored in the storage unit.

Compared to conventional technologies, the explication system and method of the present invention is to segment a word into at least one root and a remaining portion composed of the remaining letters other than the root in the word, and to explain the meaning of the word by combining the explications of the root and the remaining portion even if the word is not recorded in the word database. Consequently, a translation system can more accurately explain a word not originally stored in the word database by employing the explication system and method of the present invention.

### BRIEF DESCRIPTION OF THE DRAWINGS

FIG. 1 is a schematic diagram showing a basic structure of the explication system of the present invention;

FIG. 2 is a schematic diagram showing the contents of a root table of the explication system of the present invention; and

FIG. 3 is a schematic flow chart of the operation of the explication method of the present invention.

### DETAILED DESCRIPTION OF THE PREFERRED EMBODIMENTS

Following embodiments are employed to describe the present invention; those skilled in the art can easily understand other advantages and effects of the present invention according to the disclosure in the description. The present invention can be employed in various embodiments, the present embodiment takes English translation as an example; however which shall not be regarded as a limitation to the present invention; the explication language can also be French, German, Esperanto, Spanish, Russian and other language phylum having roots. In addition, the present embodiment takes English-to-Chinese explication (i.e. translation) as an example; however, the present invention can also be used in the explication of words in the same language, for example Spanish-to-Spanish explication. The present invention should therefore cover various modifications and variations made to the herein-described structure and operations of the present invention, provided they fall within the scope of the present invention.

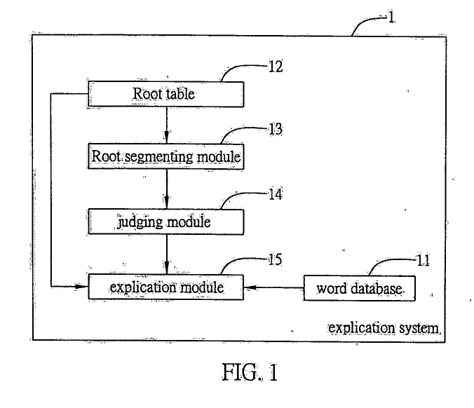

FIG. 1 illustrates a schematic diagram showing a basic structure of the explication system of the present invention. As shown in the figure, the explication system 1 of the present invention can be employed in portable electronic devices (such as electronic dictionaries, mobile phones and language translation machines) or computers to explain words having roots. The explication system 1 comprises a storage unit, a root segmenting module 13, a judgment module 14 and an explication module 15, wherein the storage unit is employed to store a word database 11 and a root table 12. It is to be noted that, the explication system of the present invention may comprise other components, but for the purpose of simplifying the figures and description, only those structures having relationship with the features of the present invention are shown in the figures, other conventional components, such as the hardware structures like processing unit and display unit are not shown in the figures.

The word database 11 is employed to store a plurality of words and corresponding explications. It is to be noted that, the techniques for implementing and calling a word database are known to those skilled in the art, thus operations and internal structure thereof will not be detailed hereinafter.

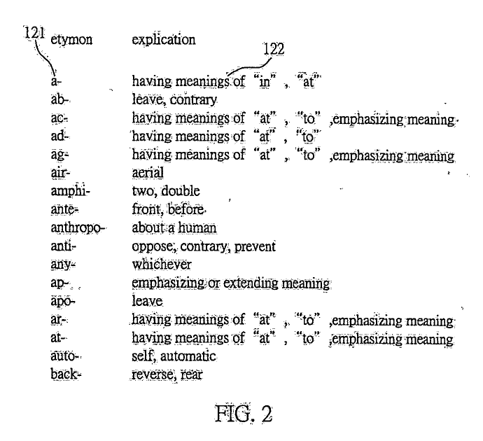

The root table 12 is employed to record word roots and corresponding explications. Referring also to FIG. 2, which shows the contents of a root table 12 in accordance with the explication system 1 of the present invention. In the present embodiment, the root table 12 at least comprises a root portion 121 and a corresponding explication portion 122. As the example shown in FIG. 2, “a-”, “ab-” and “ac-” are all roots, wherein the explication to the root “a-” is [symbol] in, at [symbol] (having the meanings of “in”, “at”), the explication to the root “ab-” is [symbol] (leave, contrary) and the explication to the root “ac-” is [symbol] at, to [symbol] (having the meanings of “at” , “to”, emphasizing). The rules of other roots and corresponding explications are the same, which will not be detailed hereinafter.

The root segmenting module 13 employs the root table to perform segmentation on words, so as to segment a word into root(s) and the remaining letters. Referring also to FIG. 2, the word “autocriticism” is taken as an example to describe the segmenting processing, wherein the root table 12 shown in FIG. 2 is firstly searched, the root segmenting module 13 is able to segment the word into “a-”, “utocriticism”; and “auto”, “criticism”.

The judgment module 13 is employed to judge whether the remaining letters after segmentation can be explained or not, that is, whether a word composed of the said remaining letters and its corresponding explication are stored in the word database 11. In the present invention, in the case of the judging “utoctiticism”, it cannot be explained because no such word is stored in the word database 11; in the case of the judging “crisicism”, the word can be explained because “criticism” is a word stored in the word database 11.

The explication module 15 explains the word according to the judgment result of the judgment module 14, if the word composed of the remaining letters after the segmenting can be explained, the explication module 15 respectively explains the root and the word composed of the remaining letters after the segmenting. In the present embodiment, the explication module 15 explains the root “auto-” and the word composed of the remaining letters after the segmenting “criticism”. According to the root table 12, “auto-” is explained as [symbol] (self, automatic), and according to the word database 11, “criticism” is explained as [symbol] (criticism, comment) (not shown).

Next, the explication module 15 combines the explication of the root and the explication of the word composed of the remaining letters after the segmenting into a combined explication. In the present embodiment, the root “auto-” of the word “autocriticism” is explained as [symbol] (self, automatic), and the word composed of the remaining letters after the segmenting “criticism” is explained as [symbol] (criticism, comment); thus the explication module 15 explains the word “autocriticism” as [symbol] (self criticism), [symbol] (self comment), [symbol] (automatic criticism), or [symbol] (automatic comment), the explication has a similar meaning to the actual meaning of the word. Generally, a user can understand the meaning of the word per se without any difficulty by further referring to its context.

In the above embodiment, the root table 12 of the explication system 1 comprises both of the roots and corresponding explications. Alternatively, the root table 12 can comprise only the roots, while the word database 11 stores the roots with corresponding explications and the words with corresponding explication altogether.

In the above embodiment, the segmenting sequence to the word “autocriticism” is from left to right (i.e. from the beginning of the word); however, it shall not be regarded as a limitation to the practical application of the present invention, the sequence of segmenting from the middle of the word, or from right to left (i.e. from the end of the word) can also be employed in the present invention, so as to accurately explain those word having root(s) in the middle thereof or at the end thereof. Additionally, regarding those words which cannot be explained, additional segmenting sequence can be used, so as to accurately explain those words having more than one root.

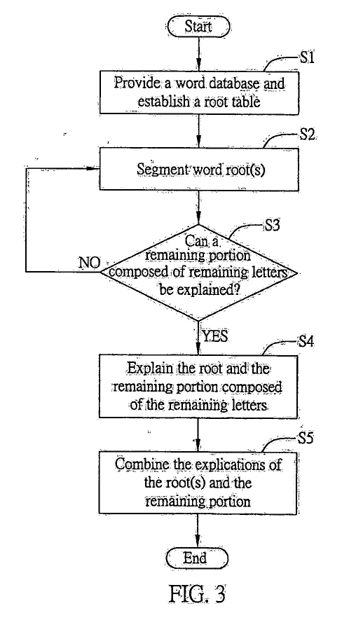

FIG. 3 is a schematic flow chart of the operation of the explication method of the present invention. The explication method of the present invention can be employed in portable electronic devices (such as electronic dictionaries, mobile phones and language translation machines) or computers to explain words having roots. As shown in the figure, first step S1 is performed by providing the word database 11 and establishing the root table 12 (as shown in FIG. 2), wherein the word database 11 stores a plurality of words and corresponding explications; the root table records a plurality of roots and corresponding explications; next, step S2 is performed.

In step S2, a word is segmented according to the root table 12 into a root portion and a remaining portion left after segmentation (i.e. remaining letters), wherein the segmenting sequence is from left to right. In the present embodiment, the word “autocriticism” is taken as an example, which is segmented into “a-” and “utocriticism” according to the root table 12; next, step S3 is performed.

In step S3, it is judged whether the remaining portion composed of the remaining letters has an explication; if yes, step S4 is performed; if no, step S2 is returned for re-segmenting the word according to the root table 12 by shifting to an alternative root and judging whether the word after the re-segmentation has an explication. In the present embodiment, if the word database 11 cannot explain the remaining portion “utocriticism” composed of the remaining letters, step S2 is returned. Step S2 re-segments the word according to the root table 12, thus re-segmenting the word into “auto” (i.e. the root) and “criticism” (i.e. the re-remaining portion composed of remaining letters); then it is judged whether the re-remaining portion “criticism” has an explication in step S3; if yes, step S4 is performed.

In step S4, the remaining portion composed of the remaining letters and the root according to the word database 11 and the root table 12 are explained; wherein according to the root table 12, “auto-” can be explained as [symbol] (self, automatic); and according to the word database 11, “criticism” can be explained as [symbol] (criticism, comment); next, step S5 is performed.

In step S5, the explication results from step S4 are combined; that is, the explications of the word “autocriticism” are [symbol] (self criticism), [symbol] (self comment), [symbol] (automatic criticism), or [symbol] (automatic comment).

In step S2, the segmenting sequence to the word “autocriticism” is from left to right, i.e. from the beginning of the word; however, it shall not be regarded as a limitation to the practical application of the present invention, the sequence of segmenting from the middle of the word, or from right to left (i.e. from the end of the word) can also be employed in the present invention, so as to accurately explain those word having root in the middle thereof or at the end thereof. Additionally, regarding those words which cannot be explained, additional segmenting sequence can be used so as to accurately explain those words having more than one root.

Accordingly, the explication system and method of the present invention is to segment a word into root(s) and a remaining portion composed of the remaining letters and to combine the explications of the root(s) and the remaining portion to give an explanation of the word even if the word is not recorded in the word database. Consequently, a translation system can more accurately explain a searched word by employing the explication system and method of the present invention.

It should be apparent to those skilled in the art that the above description is only illustrative of specific embodiments and examples of the present invention. The present invention should therefore cover various modifications and variations made to the herein-described structure and operations of the present invention, provided they fall within the scope of the present invention as defined in the following appended claims.

What is claimed is:

1. An explication system for searching an explication of a word having at least one root, the system comprising:
a storage unit for storing a plurality of words, explications corresponding to the words and a plurality of roots;
a root segmenting module for segmenting the word to be searched according to the contents stored in the storage unit so as to segment the word to be searched into the at least one root and a remaining portion other than the root;
a judging module for judging whether the remaining portion has an explication stored in the storage unit; and
an explication module for explaining the root and the remaining portion according to the explications stored in the storage unit, so as to obtain the explication of the searched word being judged by the judging module.

2. The explication system as claimed in claim 1, wherein the storage unit further stores the explications corresponding to the roots.

3. The explication system as claimed in claim 1, wherein the storage unit stores a word database and a root table, the word database is employed to store the plurality of words and their corresponding explications; the root table is employed to store the plurality of roots.

4. The explication system as claimed in claim 1, wherein the root segmenting module segments the word to be searched from left to right from the beginning thereof.

5. The explication system as claimed in claim 1, wherein the root segmenting module segments the word to be searched from the middle portion thereof.

6. The explication system as claimed in claim 1, wherein the root segmenting module segments the word to be searched from right to left from the end thereof.

7. An explication method for explaining a word having at least one root, the method comprising:
providing a storage unit for storing a plurality of words, explications corresponding to the words and a plurality of roots;
segmenting the word to be explained according to the contents stored in the storage unit so as to segment the word to be explained into the at least one root and at least a remaining portion;
judging whether the remaining portion has an explication stored in the storage unit; and
explaining the root and remaining portion according to the explications stored in the storage unit.

8. The explication method as claimed in claim 7, wherein the storage unit further stores the explications corresponding to the roots.

9. The explication method as claimed in claim 7, wherein the storage unit stores a word database and a root table, the word database is employed to store the plurality of words and corresponding explications, the root table is employed to store the plurality of roots.

10. The explication method as claimed in claim 7, wherein the word is segmented from left to right from the beginning thereof.

11. The explication method as claimed in claim 7, wherein the word is segmented from right to left from the end thereof.

12. The explication method as claimed in claim 7, wherein the word is segmented from the middle portion thereof.
